(19) United States
(12) Patent Application Publication
(10) Pub. No.: US 2006/0217839 A1
(43) Pub. Date: Sep. 28, 2006

(54) Object management apparatus, object management method and computer program product

(75) Inventors: Takahiro Kawamura, Kanagawa (JP); Kouji Ueno, Kanagawa (JP); Tetsuo Hasegawa, Tokyo (JP); Akihiko Ohsuga, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/313,644

(22) Filed: Dec. 22, 2005

(30) Foreign Application Priority Data
Mar. 28, 2005 (JP) 2005-92814

(51) Int. Cl. G06F 19/00

(52) U.S. Cl. 700/245

(57) ABSTRACT

An object management apparatus for managing an object which executes a process includes an execution conditions holding unit that holds the process and corresponding execution condition indicating a first status of the object as a prerequisite for executing the process; an execution instruction acquisition unit that acquires an execution instruction indicating the process; a status information acquisition unit that acquires status information indicating a second status of the object from the object; and a status determining unit that determines whether the process indicated in the execution instruction can be executed by the object, based on the first status indicated in the execution condition corresponding to the process indicated in the execution instruction and the second status indicated the status information.

### CROSS-REFERENCE TO RELATED APPLICATIONS

This application is based upon and claims the benefit of priority from the priority Japanese Patent Application No. 2005-092814, filed on Mar. 28, 2005; the entire contents of which are incorporated herein by reference.

### BACKGROUND OF THE INVENTION

1. Field of the Invention

This invention relates to an object management apparatus, an object management method and an object management program for managing an object accessible from outside.

2. Description of the Related Art

Conventionally, an apparatus is known to retrieve the service of a software program made public on a network. Japanese Patent Application Laid-Open No. 2004-118722, for example, discloses a service information providing system having a mechanism for applying the similarity decision of ontology to the retrieval conditions based on the program language required for service retrieval.

Many software programs in an environment where devices closely associated with hardware coexist are created to provide the service to many people at a time. The bank service, for example, can be accessed by thousands of people at a time.

It may be difficult for a sensor or a robot, however, to provide a service to many people at a time due to the limited physical resources. For example, the robot can speak to only one person at a time. In other words, the service of speech cannot be provided to a plurality of persons at a time.

As described above, the service provided by the sensor or the robot is limited more than the Web service. In providing-the service by the sensor or the like, therefore, it is important to take the operating situation into consideration. The term “service” used herein is defined as a function, namely an executable process of each device, program, or the like.

### SUMMARY OF THE INVENTION

According to one aspect of the present invention, an object management apparatus for managing an object which executes a process, comprises an execution conditions holding unit that holds the process and corresponding execution condition indicating a first status of the object as a prerequisite for executing the process; an execution instruction acquisition unit that acquires an execution instruction indicating the process; a status information acquisition unit that acquires status information indicating a second status of the object from the object; and a status determining unit that determines whether the process indicated in the execution instruction can be executed by the object, based on the first status indicated in the execution condition corresponding to the process indicated in the execution instruction and the second status indicated the status information.

According, to another aspect of the present invention, an object management method for managing an object which executes a process, comprises acquiring an execution instruction indicating the process to be executed by the object; acquiring status information indicating a first status of the object from the object; and determining whether the process indicated in the execution instruction can be executed by the object, based on the first status indicated in the execution condition corresponding to the process indicated in the execution instruction and the second status indicated the status information.

According to still another aspect of the present invention, a computer program product causes a computer to perform the method according to the present invention.

### BRIEF DESCRIPTION OF THE DRAWINGS

FIG. 1 is a diagram showing a general configuration of an object management system according to a first embodiment;

FIG. 2 is a block diagram showing a functional configuration of an object management apparatus;

FIG. 3 is a diagram schematically showing the data structure of a service DB;

FIG. 4 is a diagram schematically showing the data structure of a status information DB;

FIG. 5A is a diagram schematically showing the taxonomy held by a taxonomy DB;

FIG. 5B is a diagram schematically showing the taxonomy held by the taxonomy DB;

FIG. 6 is a block diagram showing a functional configuration of a robot;

FIG. 7 is a flowchart showing the object management process executed by the object management apparatus;

FIG. 8 is a flowchart showing the detail of the robot status determining process (step S104);

FIG. 9 is a diagram showing a hardware configuration of the object management apparatus according to the first embodiment;

FIG. 10 is a diagram schematically showing the data structure of a status information DB according to a third modification; and

FIG. 11 is a block diagram showing a functional configuration of an object management apparatus according to a second embodiment.

### DETAILED DESCRIPTION OF THE PREFERRED EMBODIMENTS

An object management apparatus, an object management method and a computer program product of embodiments according to the present invention are described in detail below with reference to the drawings. The invention is not limited to these embodiments.

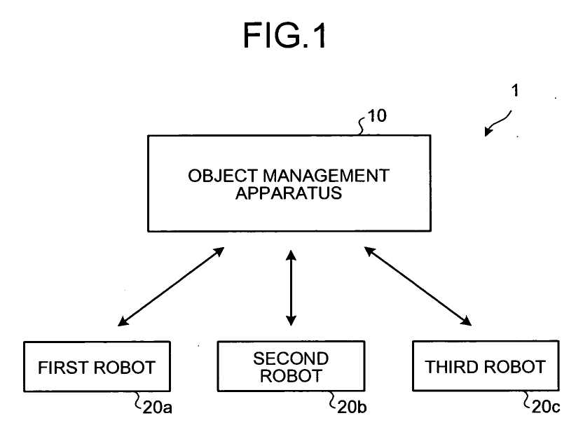

FIG. 1 is a diagram showing a general configuration of an object management system according to a first embodiment. The object management system 1 includes an object management apparatus 10 and a plurality of objects managed by the object management apparatus 10. According to this embodiment, the objects correspond to robots 20a to 20c. The object management apparatus 10 is communicable with the robots 20a to 20c through, for example, a network.

The robots 20 carry out various services. The term “service” is defined as a function that can be executed by the robots 20. Specifically, it includes the movement to a predetermined destination or an audio output.

The object management apparatus 10 manages the robots 20a to 20c. The object management apparatus 10, upon acquisition of an instruction to carry out a predetermined service, selects a robot to carry out the service, out of the three robots 20a to 20c.

Specifically, the status of each of the robots 20a to 20c is specified, and a serviceable robot is selected. The robot thus selected carries out the service in accordance with the service execution instruction. One or a plurality robots may be instructed to carry out the service.

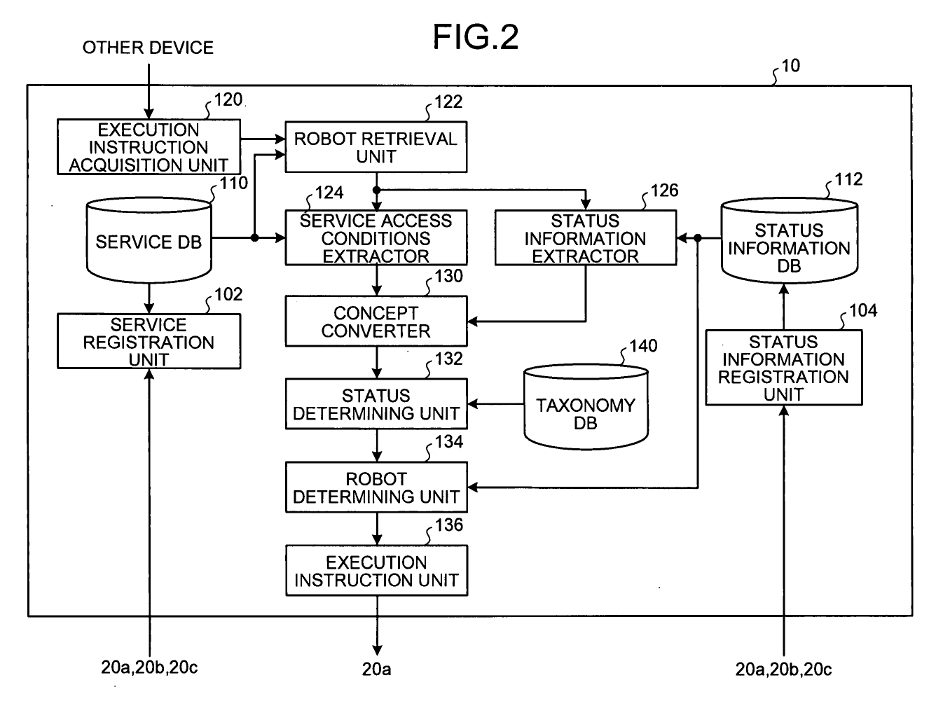

FIG. 2 is a block diagram showing a functional configuration of the object management apparatus 10. The object management apparatus 10 includes a service registration unit 102, a status information registration unit 104, a service data base (DB) 110, a status information DB 112, an execution instruction acquisition unit 120, a robot retrieval unit 122, a service access conditions extractor 124, a status information extractor 126, a concept converter 130, a status determining unit 132, a robot determining unit 134, an execution instruction unit 136 and a taxonomy DB 140.

The service registration unit 102 acquires the services that can be provided by the robots 20a to 20c and the service access conditions for the respective services and registers them in the service DB 110. The service access conditions are those conditions to be met by the status information immediately before service execution, and may be referred to as “execution conditions”.

The status information is the information indicating the robot status. The status information according to this embodiment is indicated as a mass of a plurality of status variables. The status variable is the information indicating the present state of the robots 20 such as the on-off state of the power supply or the present position of the robots 20. The status variable is at a primitive level and indicates the status which can be assumed by any of the robots. The status information indicating that the power supply is turned on and the present position is X, for example, is expressed as a mass of the status variable indicating that the power supply is on and the status variable indicating that the present position is X.

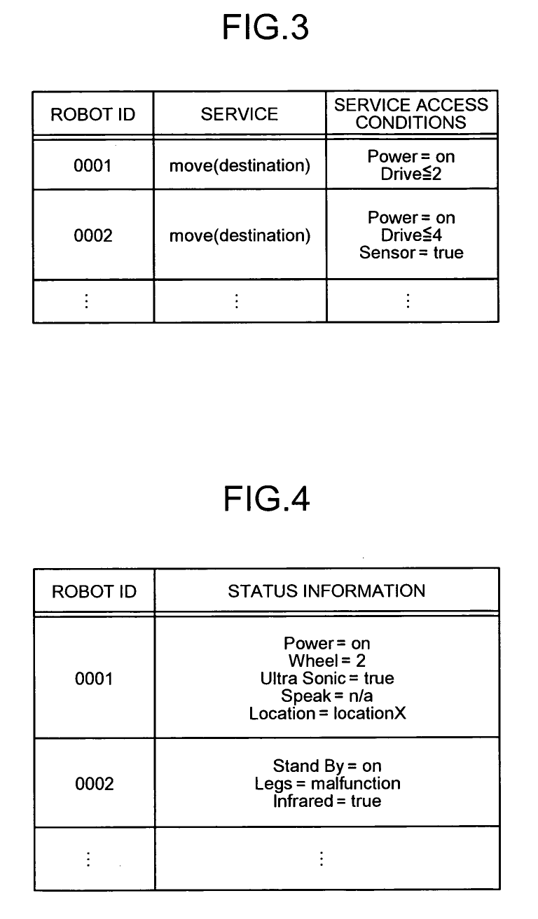

FIG. 3 is a diagram schematically showing a data structure of the service DB 110.

The service DB 110 holds the services provided by the robots 20a to 20b to be managed by the object management apparatus 10. Specifically, the service DB 110 holds the services to be provided by each robot with the corresponding service access conditions (execution conditions) and the corresponding robot ID for identifying each robot. In the case shown in FIG. 3, the robot ID “0011” corresponds to “move.”

Also, the following status variables are held as the service access conditions for “move.”

Power=On

Drive≦2

where “Power=On” indicates that the power supply is turned on, and “Drive≦2” indicates that the drive value is not more than 2. The atomic concept in the status variables such as “Power” and “Drive” is defined beforehand.

Specifically, the robot identified by the robot ID “0001” is required to be movable, and as a prerequisite for movement, the power supply is required to be turned on and the drive value not more than 2.

Also, the robot ID “0002” similarly corresponds to “move.” The following status variables are held as the service access conditions for “move.”

Power=On

Drive≦4

Sensor=true

where Sensor=true indicates the provision of a sensor.

Specifically, the robot identified by the robot ID “0002” is required to be movable and as a prerequisite for “move”, the power supply is required to be turned on, the drive value not more than 4 and the sensor available.

When a single robot can carry out a plurality of services, a plurality of the services are held with the corresponding single robot.

Returning to FIG. 2, the status information registration unit 104 acquires from the robots 20a to 20c the status information indicating the status of the robots 20a to 20c, and registers it in the status information DB 112. FIG. 4 is a diagram schematically showing the data structure of the status information DB 112. The status information DB 112 holds the robot status information with corresponding robot identification information. In the case shown in FIG. 4, the following mass of status variables are held as the status information for the robot ID “0001.”

Power=On

Wheel=2

UltraSonic=True

Speak=n/a

Location=locationX

where “WHEEL=2” indicates that there are two wheels, “UltraSonic=True” that an infrared light sensor is provided, “Speak=n/a” that the audio output function is not available, and “Location=locationX” that the present position is locationX.

Also, the following mass of status variables is held as the status information for the robot ID “0002”:

StandBy=On

Legs=malfunction

Infrared=True

where “StandBy=On” indicates that the power supply is in standby state, “Legs=malfunction” that the legs, though available, are out of order, and “Infrared=True” that the infrared light sensor is available.

Further, the status information DB 112 holds the registration date/hour on which the status information is registered by the status information registration unit 104. Specifically, the status information DB 112 further holds the change frequency of the status information of each robot. The change frequency is defined as information indicating the number of times the robot status has changed in the past. In other words, it is the information indicating the number of times the status information in the status information DB 112 has changed in the past.

The change frequency may alternatively be the information indicating the number of times the status information has changed during a predetermined period in the past.

The status information registration unit 104 registers only those status variables which are included in the mass of status variables as the status information already registered in the status information DB 112 and which have undergone a change. The status variables not registered are considered in the same state as the status variables already registered. As a result, the processing efficiency can be improved.

Further, the status information DB 112 may hold the initial values in advance. The status information registration unit 104 registers a different status variable only when the status variable is different from the initial value held in the status information DB 112. The status variables not registered in the status information DB 112 are considered in the same state as the initial value. As a result, the processing efficiency is improved.

Returning to FIG. 2, an execution instruction acquisition unit 120 acquires the service execution instruction given from an external device to carry out a predetermined service. Specifically, the service execution instruction is acquired from another device connected to the object management apparatus 10. As another example, the instruction can be acquired directly from the user, or from any one of the robots 20a to 20c. The robot retrieval unit 122, by referring to the service DB 110, retrieves a robot adapted to carry out the service corresponding to the service execution instruction acquired by the execution instruction acquisition unit 120.

The service access conditions extractor 124 extracts the service access conditions held in the service DB 110 with the corresponding service of the robot retrieved by the robot retrieval unit 122. The status information extractor 126 extracts the status information of the robot retrieved by the robot retrieval unit 122 from the status information DB 112.

The concept converter 130 acquires the service access conditions from the service access conditions extractor 124, and converts the mass of status variables contained in the service access conditions into the description logic concept. The concept converter 130 also acquires the status information from the status information extractor 126, and converts the mass of status variables contained in the status information into the description logic concept.

The status determining unit 132 determines whether the robot is in the state meeting the service access conditions, based on the description logic concept for the service access conditions and the description logic concept for the status information. In the process, the taxonomy held in the taxonomy DB 140 is referred to.

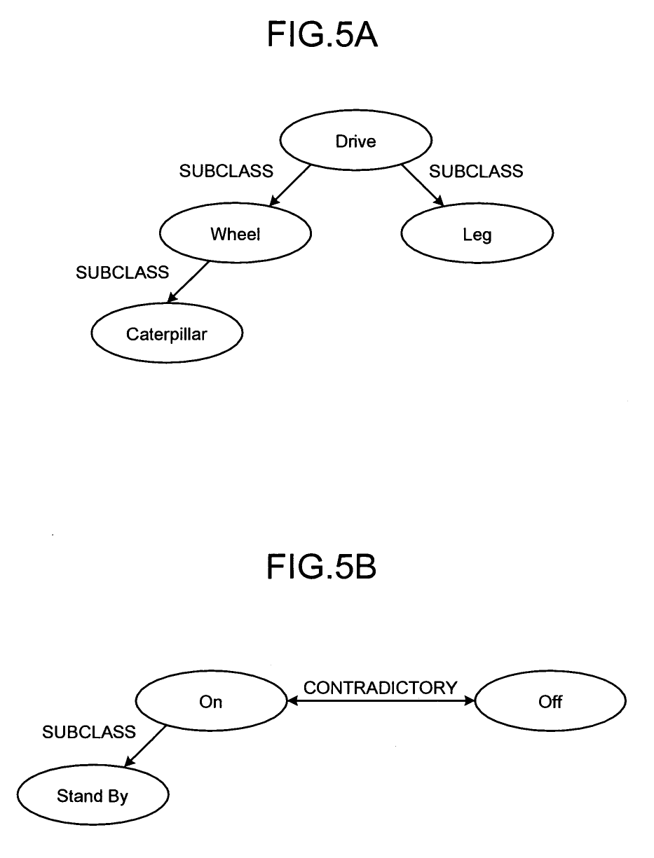

FIGS. 5A and 5B are diagrams schematically showing the taxonomy held by the taxonomy DB 140. The taxonomy is a graph defining the connection between atomic concepts, namely a graph indicating the relation between status variables. The taxonomy and the taxonomy DB 140 may be referred as to status variables relation information and a status variables relation information holding unit, respectively.

As shown in FIG. 5A, for example, “Drive” includes “Wheel.” Further, “Wheel” includes “Caterpillar.” The information indicating this connotative relation is held as a taxonomy in the taxonomy DB 140.

Also, as shown in FIG. 5B, “On” and “Off” are contradictory with each other. The information indicating this contradictory relation is also held as a taxonomy in the taxonomy DB 140.

As described above, the taxonomy defines the relation between status variables. Even when status variables fail to coincide with each other, therefore, it is possible to determine whether the status variables substantially coincide with each other or not, by referring to the taxonomy.

Assume, for example, that “Power=On” is set as the service access conditions and that “StandBy=On” is set as the status information. These status variables are different from each other. In the taxonomy, however, “StandBy” is included in “On”, and therefore it can be determined that the status information coincides with the access conditions.

Returning to FIG. 2, the robot determining unit 134 determines a robot to execute the service, based on the result of determination in the status determining unit 132. Accordingly, the robot determining unit 134 may be referred to as an execution control unit. The execution instruction unit 136 sends an execution instruction to the robot determined by the robot determining unit 134. When the first robot 20a is determined, for example, the execution instruction is given to the first robot 20a.

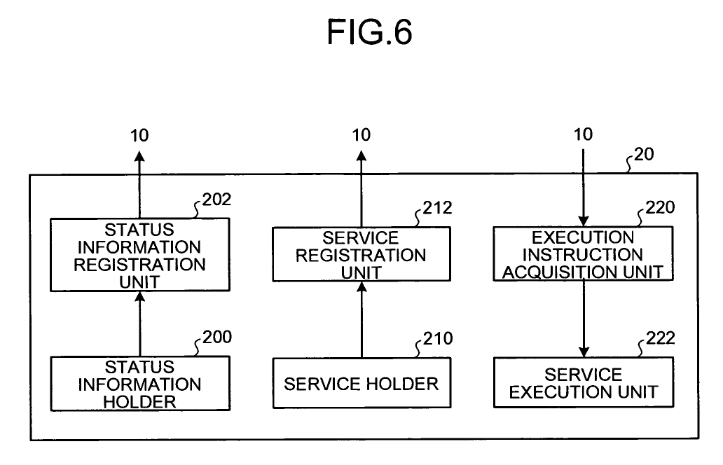

FIG. 6 is a block diagram showing a functional configuration of the robot 20. The robot 20 includes a status information holder 200, a status information registration unit 202, a service holder 210, a service registration unit 212, an execution instruction acquisition unit 220 and a service execution unit 222.

The status information holder 200 holds the status information indicating the present state of the robot 20. Specifically, a mass of status variables is held as status information. The status information registration unit 202 registers the mass of status variables in the object management apparatus 10 as the status information held by the status information holder 200. The status information registration unit 202 registers the status information at predetermined regular intervals of time.

The registration can be made at an arbitrary timing. As another example, the status information may be registered in response to an instruction from the object management apparatus 10 immediately before the status information extractor 126 extracts the status information. As a result, the object management apparatus 10 can select a proper robot based on the robot status immediately before selection.

The service holder 210 holds the services that can be provided by the robots 20 and the service access conditions. The service registration unit 212 registers the services and the service access conditions held by the service holder 210 in the object management apparatus 10.

The execution instruction acquisition unit 220 acquires the service execution instruction for a predetermined service from the object management apparatus 10. The service execution unit 222 executes the service in accordance with the service execution instruction acquired by the execution instruction acquisition unit 220.

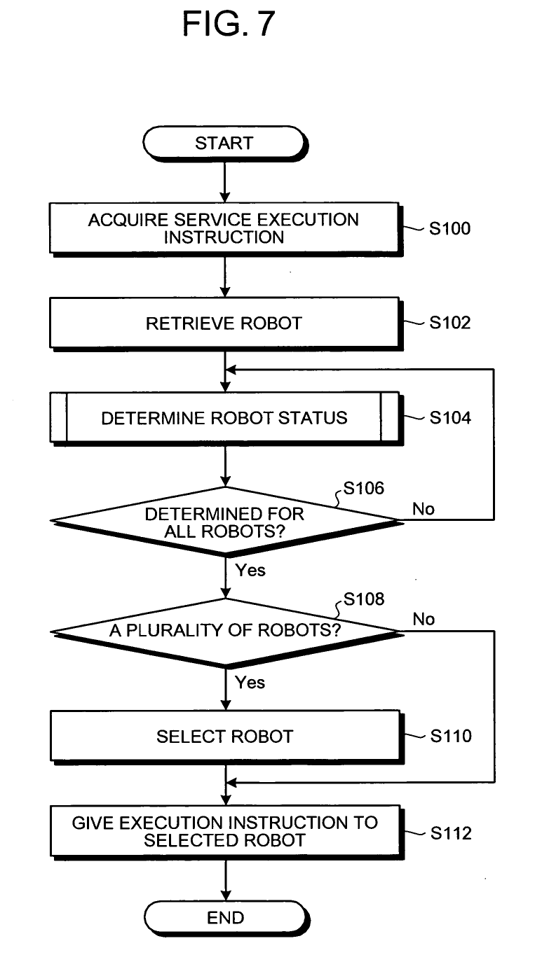

FIG. 7 is a flowchart showing the object management process executed by the object management apparatus 10. First, the execution instruction acquisition unit 120 acquires a service execution instruction from an external device (step S100). An explanation is made about a case in which the service execution instruction is acquired from a device other than the robots 20a to 20c and connected to the object management apparatus 10.

Next, the robot retrieval unit 122 retrieves a robot capable of executing the service indicated in the service execution instruction while referring to the data stored in the service DB 110 (step S102). Then, it is determined whether the state of the robot specified by the robot retrieval unit 122 coincides with the service access conditions of the service indicated in the service execution instruction (S104).

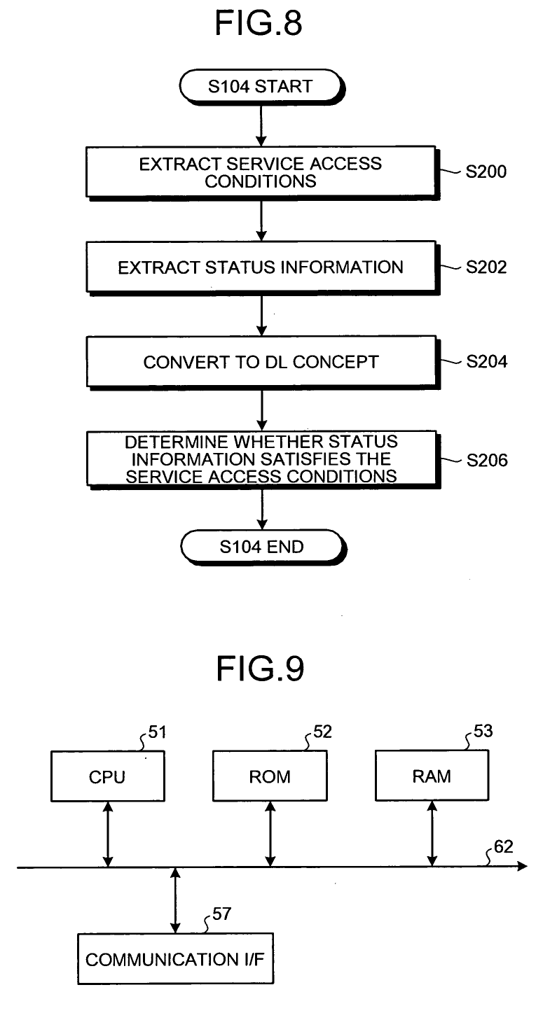

FIG. 8 is a flowchart showing the details of the robot status determining process (step S104). The service access conditions extractor 124 extracts from the service DB 110 the service access conditions for the service indicated in the service execution instruction given to the robot retrieved by the robot retrieval unit 122 (step S200). Also, the status information extractor 126 extracts the status information of the robot specified by the robot retrieval unit 122, from the status information DB 112 (step S202).

Next, the concept converter 130 converts the service access conditions extracted by the service access conditions extractor 124 into a DL concept. The status information extracted by the status information extractor 126 is converted into a DL concept (step S204).

The status determining unit 132, by comparing the DL concept of the access conditions with the DL concept of the mass of status variables, determines whether the robot status satisfies the service access conditions or not (step S206). In this way, the status determining process (step S104) is completed.

Returning to FIG. 7, the status determining process (step S104) described above is executed for all the robots specified by the robot retrieval unit 122 (YES at step S106).

When a plurality of robots are specified as satisfying the access conditions (YES at step S110), the robot determining unit 134 selects one of them (step S110), and the execution instruction unit 136 issues a service execution instruction to the robot selected by the robot determining unit 134 (step S112). In this way, the object management process is completed.

At step S110, the robot determining unit 134 selects a robot based on the change frequency, the distance between the concepts and the importance degree of the status variables stored in the status information DB 112.

Specifically, a robot having a low change frequency is selected in priority. With a robot of which the status information undergoes frequent changes, the status information is liable to have been changed with the lapse of time from the acquisition of the status information. Such a robot, therefore, is set to a low priority. The robot determining unit 134 selects a robot of high priority.

A robot having a low change frequency of the status information is high in priority and has a high chance of being selected. As a result, it is possible to avoid a robot of which the status changes with time to such an extent as to fail to meet the robot access conditions when the robot is determined.

Further, the robot determining unit 134 selects a robot whose distance between status variables is short in taxonomy. In the taxonomy DB 140, for example, assume that the taxonomy is defined as follows:

Drive ⊃ Wheel ⊃ Caterpillar

where “Drive ⊃ Wheel” indicates that “wheel” is included in “Drive”. Also, assume that the status variable of the first robot 20a is “Wheel” and the status variable of the second robot 20b is “Caterpillar.” In this case, both robots 20a, 20b satisfies “Drive.” In taxonomy, however, “Caterpillar” forms a connotative relation with “Drive” through “Wheel.” Therefore, “Wheel” is shorter in distance from “Drive.”

In this case, it is determined that the distance between status variables is shorter for the first robot 20a having the status variable “Wheel.” The robot having a shorter distance is set to a higher priority. As a result, the first robot 20a set to a higher priority is selected.

The status variables having a shorter distance in taxonomy tend to have a meaning of a higher similarity. By selecting a robot having a status variable shorter in distance, therefore, a robot in a state more suitable for the service access conditions can be determined.

In the taxonomy DB 140, for example, assume that the following taxonomy is defined.

Speak ⊃ SpeakWithVolume ⊃ SpeakWithVolumeEnglishOnly Also assume that the designated state is “Speak”, the status variable of the first robot 20a is “SpeakWithVolumeEnblishOnly”, and the status variable of the second robot 20b is “SpeakWithVolume.” With regard to the distance between status variables, however, “SpeakWithVolume” is nearer to the designated state “Speak”. Thus, the second robot 20b is set to a higher priority than the first robot 20a, and selected.

Further, assume that the conditions for “Drive” and the conditions for “Speak” coexist, “Drive” is set to a higher priority for the first robot 20a than for the second robot 20b, and that “Speak” is set to a higher priority for the second robot 20b than for the first robot 20a. In total, the priority of the two robots 20a, 20b become equal to each other.

In this case, the robot determining unit 134 selects a robot having a higher importance degree of the status variable. Specifically, upon determination from the distance between status variables that the robots are in the same order of priority, the priority for a status variable of a higher importance degree is weighted.

Specifically, “Drive” is set to a higher importance degree than “Speak.” In this case, the total priority in the two conditions is higher for the first robot 20a having a higher priority of “Drive”, and therefore the first robot 20a is selected. The importance degree is assumed to be held with a corresponding status variable stored as service access conditions in the service DB 110.

As described above, an optimal robot can be selected based on the change history, the distance between status variables and the importance degree of the status variables.

A more specific process of the object management apparatus 10 is explained. Assume that the first robot 20a has the service and the service access conditions of the robot ID “0001” shown in FIG. 3. Also, assume that the second robot 20b has the service and the service access conditions of the robot ID “0002” shown in FIG. 3. Further, the status information of the first robot 20a and the second robot 20b include the status information of the robot ID “0001” and the robot ID “0002”, respectively, shown in FIG. 4.

Under this condition, assume that the execution instruction acquisition unit 120 has acquired the execution instruction of the following flow:

move(locationA)

pickup(objectC)

move(locationB)

In this case, the robot retrieval unit 122 retrieves the robot having the service “move(location)” while referring to the service DB 110 (step S102).

As shown in FIG. 3, the first robot 20a and the second robot 20b both have “move(location)” as a service. Thus, these two robots 20a, 20b are specified.

Next, the service access conditions extractor 124 extracts the service access conditions corresponding to the first robot 20a and the second robot 20b in FIG. 3 (step S200). Also, the status information extractor 126 extracts the status information corresponding to the first robot 20a and the second robot 20b in FIG. 4 (step S202). Then, the concept converter 130 converts them into the DL concept (step S204).

The status information of the first robot 20a is converted to the following DL concept:
powerOn ┌ ┐ ≦2have.Wheel ┌ ┐ ∃ contain. (Sensor ┌ ┐ UltraSonic) ┌ ┐ ┐ Speak ┌ ┐ locate(locationX)
   This DL concept indicates that the power supply is in on state, two or less wheels are available, at least one ultrasonic sensor is available, the audio output function is not available and the present position is X.

The status information of the second robot 20b is converted to the following LD concept:
power.StandBy ┌ ┐ ┐ have.Legs 539 ┐ ∃ contain. (Sensor ┌ ┐ Infrared)
   This DL concept indicates the power standby mode, no legs and the availability of at least one infrared light sensor.

Also, the service access conditions for the first robot 20a are converted into the following LD concept:
power.On ┌ ┐ ≦4have.Drive ┌ ┐ ∃ contain.Sensor
   The service access conditions for the second robot 20b, on the other hand, are converted to the following DL concept:
power.On ┌ ┐ ≦2have.Drive

Next, the status determining unit 132, based on the DL concept obtained by the concept converter 130, determines whether the state of each robot coincides with the service access conditions thereof (step S206).

First, the determination is made for the first robot 20a. Specifically, the DL concept of the status information of the first robot 20a is disassembled as follows:

powerOn

≦2have.Wheel

∃ contain. Sensor

∃ contain. Ultrasonic

┐Speak

locate(locationX)

Also, the service access conditions for the first robot 20a are disassembled as follows:

power.On

≦4have.Drive

∃ contain.Sensor

Next, the term to be paired with each term obtained by disassembling the status information is specified from the terms obtained by disassembling the service access conditions. The terms carrying the same number constitute a pair.

Status information:

PowerOn (1)

≦2have.Wheel (2)

∃ contain. Sensor (3)

∃ contain. Ultrasonic

┐Speak

locate(locationX)

Service access conditions:

power.On (1)

≦4have.Drive (2)

∃ contain.Sensor (3)

The terms (1) and (3) are identical in description and equivalent to each other. Therefore, these service access conditions are satisfied.

In terms (2), on the other hand, “2 or less” is included in “4 or less”. Also, the taxonomy shown in FIG. 5A indicates that “Wheel” is included in “Drive.” Thus, the status information is included in the service access conditions. Also in this case, therefore, the service access conditions are satisfied. As a result, it is determined that the first robot 20a satisfies the service access conditions and can be accessed.

Next, the determination is made for the second robot 20b. Specifically, the DL concept of the status information of the second robot 20b is disassembled as follows:

power.StandBy

┐ have.Legs

∃ contain.Sensor

∃ contain.Infrared

Also, the service access conditions of the second robot 20b are disassembled as follows:

power.On

≦2have.Drive

Next, the terms constituting a pair are specified from the status information and the service access conditions. The terms carrying the same number constitute a pair.

Status information:

power.StandBy (4)

┐ have.Legs (5)

∃ contain.Sensor

∃ contain.Infrared

Service access conditions:

power.On (4)

≦2have.Drive (5)

With regard to the terms (4), the taxonomy in FIG. 5B shows the relation that “StandBy” is included in “On.” This indicates that the term (4) of the service access conditions is satisfied. With regard to (5), on the other hand, neither connotation nor equivalence is established. This indicates that the term (5) of the service access conditions is not satisfied. It is thus determined that the second robot 20b fails to satisfy the service access conditions and cannot be accessed.

Through the process described above, the accessible robot is limited to the first robot 20a (No at step S108). The robot determining unit 134, therefore, selects the first robot 20a as a service robot. The execution instruction unit 136 instructs the robot 20a to execute the service “move(locationA)” (step S112).

As the result of this process, the service execution instruction “move(locationA)” is sent to the first robot 20a. The first robot 20a which has received this execution instruction satisfies the service access conditions and therefore can properly execute the service.

As described above, according to this embodiment, upon receipt of the service execution instruction from a device other than the robots 20a to 20c, the proper one of the robots 20a to 20c can be rendered to provide the service. When the service execution instruction is acquired from the first robot 20a, on the other hand, the second robot 20b and the third robot 20c other than the first robot 20a can be rendered to provide the service.

Also, according to this embodiment, the robot status is specified using the description logic so that the robot in proper state can execute the predetermined service. In the description logic, the robot status can be positively determined logically. Another advantage is that there is no need of laying out the rule manually. For the detail of the description logic, refer to “The Description Logic Handbook, Cambridge University Press, 2003.”

Also, according to this embodiment, the contents of the process can be added or otherwise changed only by changing the contents of the process in the object management apparatus 10 without changing the process of the robot itself.

FIG. 9 is a diagram showing a hardware configuration of the object management apparatus 10 according to the first embodiment of the invention. The object management apparatus 10 as a hardware configuration includes a ROM 52 for storing the object management program to execute the object management process in the object management apparatus 10, a CPU 51 for controlling the respective parts of the object management apparatus 10 in accordance with the program stored in the ROM 52, a RAM 53 for storing various data required for controlling the object management apparatus 10, a communication I/F 57 connected to a network for conducting communication and a bus 62 for connecting each part.

The object management program of the object management apparatus 10 described above may alternatively be supplied as a file in a format that can be installed or executed and recorded in a computer readable recording medium such as a CD-ROM, a floppy® disk (FD) or a DVD.

In this case, the object management program is executed by being read from the recording medium and loaded onto the main storage unit, so that each part described above with reference to the software configuration is generated on the main storage unit.

Also, the object management program according to this embodiment can be stored on a computer connected to a network such as the Internet and provided by being downloaded through the network.

An embodiment of the invention is described above and can be variously modified or altered without departing from the scope and spirit of the invention.

In a first modification of this embodiment, a single robot, instead of three robots 20a to 20c in the above-mentioned embodiment, can be managed by the object management apparatus 10. In such a case, it is determined whether the single robot can execute the predetermined service or not. As another example, the object management apparatus 10 can manage more than three robots 20.

Also, according to this embodiment, the object management apparatus 10 manages the robots, to which the object of the invention is not limited. The Web server or a ubiquitous device, for example, can also be an object.

As a second modification of this embodiment, the object management apparatus 10 compares the various status variables contained in the robot status information and the service access conditions using the description logic. Nevertheless, the invention is not limited to such a method of comparison.

As another example, the rule-based reasoning, Bayesian Network, the neural network or the first order predicate logic may be used. Nevertheless, the description logic is preferable to execute the determining process positively.

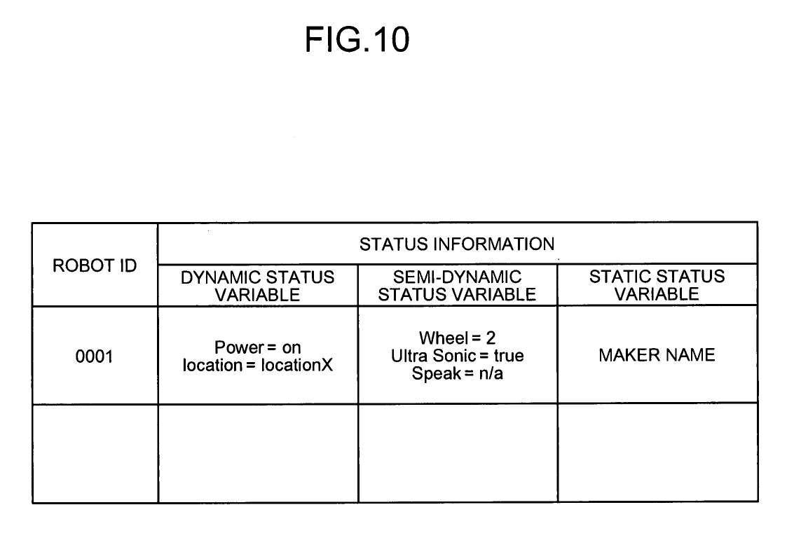

As a third modification, the status information DB 112 may store the status variables divided into the dynamic status variables, the semi-dynamic status variables and the static status variables. FIG. 10 is a diagram schematically showing the data structure of the status information DB 112 according to the third modification.

The status information DB 112 according to the third modification holds the dynamic status variables, the semi-dynamic status variables and the static status variables as status variables with corresponding robot IDs. The dynamic status variable is defined as a variable on the sequentially changing state such as the idle mode, the present position or the CPU load. The semi-dynamic status variable is defined as a variable not subjected to a frequent change such as the number of arms or the presence or absence of a sensor. The static status variable is a variable not changed after manufacture such as the maker name.

Based on these status variables, the status determining unit 132 determines the status stepwise, namely whether the dynamic status variables highly likely to change satisfy the service access conditions or not. When the dynamic status variables fail to satisfy the service access conditions, the robot involved is removed as an object of execution. When the dynamic status variables satisfy the service access conditions, on the other hand, the status determining unit 132 further determines whether the semi-dynamic status variables satisfy the service access conditions or not. When the semi-dynamic status variables satisfy the service access conditions, the status determining unit 132 further determines whether the static status variables satisfy the service access conditions or not.

By processing the dynamic status variables in the descending order of the likeliness to satisfy the service access conditions as described above, the processing efficiency is improved.

According to this embodiment, the status information registration unit 104 registers the status variables acquired from the robot in the status information DB 112 as the dynamic status variables, the semi-dynamic status variables and the static status variables, respectively. The status information acquired by the status information registration unit 104 from the robots 20a to 20c are assigned the information distinguishing the dynamic status variables, the semi-dynamic status variables and the static status variables from each other. The status information registration unit 104 distinguishes the status variables based on the information thus assigned. The status information registration unit 104 may be referred to as a status variable specifying unit.

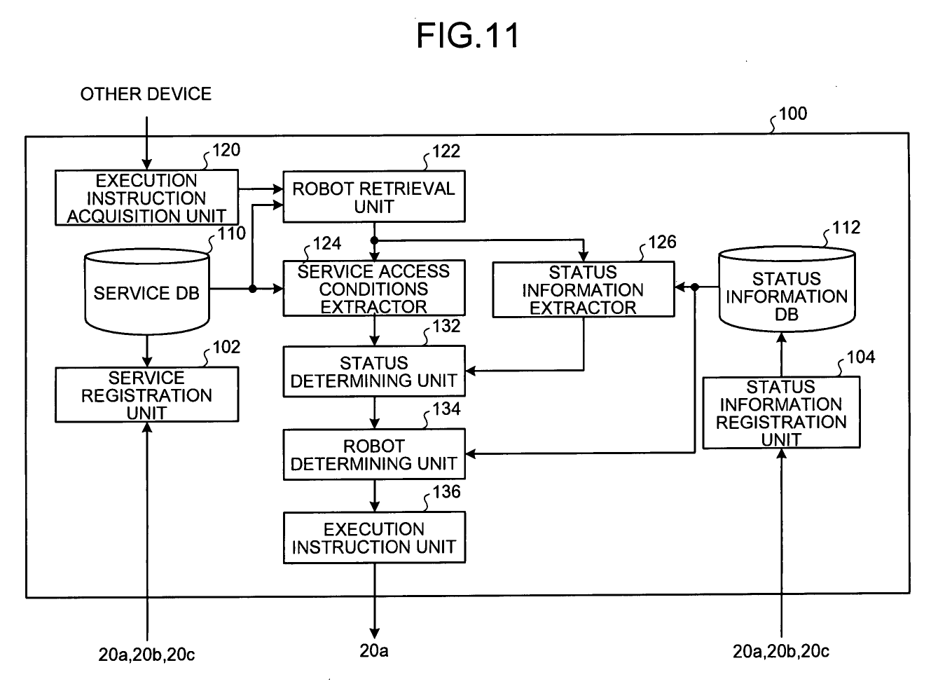

Next, the object management system according to a second embodiment is explained. FIG. 11 is a block diagram showing a functional configuration of the object management apparatus 100 according to the second embodiment. As shown in FIG. 11, the object management apparatus 100 has no concept converter 130, since the object management apparatus 100 converts no concept. In the status determining process (step S104), the status determining unit 132 determines, by comparing the status variables with each other to calculate a degree of coincidence between status variables, whether the status information satisfies the service access conditions or not.

Specifically, assume that the status information of the robot 20a is indicated by the following status variables:

POWER=On (1)

WHEEL=2 (2)

ULTRA_SONIC=True

SPEAK=n/a

LOCATION=tokyo

Also, assume that the service access conditions are indicated by the following status variables:

POWER=On (1)

WHEEL=2 (2)

The terms (1) coincide with each other, and so do the terms (2). In other words, the status information and the service access conditions partially coincide with each other. It is thus determined that the robot status information satisfies the service access conditions. By comparing the status variables with each other in this way, it can be determined whether the status information satisfies the service access conditions or not.

The number of the status variables required to be coincident with each other to satisfy the service access conditions can be set in advance. When the preset number of status variables coincide with each other, it is determined that the status information satisfies the service access conditions. Specifically, the coincidence degree is set in advance and when the actual coincidence degree is not less than the preset value, it is determined that the status information satisfies the service access conditions.

Alternatively, the status variables in synonymic relation with each other may be registered in advance. Even different status variables can be determined coincident, therefore, if in synonymic relation with each other.

The other parts of the configuration and the processes of the object management system according to the second embodiment are similar to those of the object management system 1 according to the first embodiment.

As explained with reference to the first and third modifications of the first embodiment, when the status information DB 112 holds the dynamic status variables, the semi-dynamic status variables and the static status variables in distinction from each other, the status determining unit 132 first compares the dynamic status variables with the status variables contained in the service access conditions. When the coincidence degree is less than a predetermined value, it is determined that the status information fails to coincide with the service access conditions. When the coincidence degree is not less than the predetermined value, on the other hand, the semi-dynamic status variables are further compared with the status variables contained in the service access conditions.

As another example, the object management system may assign the label name to each robot status and specify the robot status based on the label name. Specifically, the status information DB 112 of the object management apparatus 100 holds the label name indicating a predetermined status as the status information. Also, the service DB 110 holds the label name indicating a predetermined status as the service access conditions. According to whether the label names are coincident with each other or not, it is determined whether the robot status coincides with the service access conditions or not.

In this case, the status information holder 200 of each of the robots 20a to 20b holds the label name indicating the robot status. The service holder 210 holds the label name indicating a predetermined status as the service access conditions.

Assume, for example, that the label name indicating the present state of the robot 20a is “IDOL”. Also, assume that the label name of the service access conditions is “IDOL”. In this case, the label names coincide with each other, and therefore it is determined that the service access conditions are satisfied. The conditions on which the label names are determined coincident with each other can be arbitrarily set. When a character string is partially coincident, for example, it can be determined that the label names coincide with each other. Further, when a predetermined part of a character string is coincident, it can be determined that the label names coincide with each other. Moreover, when a part representing a predetermined proportion of a character string is coincident, it can be determined that the label names coincide with each other. Further, label names in synonymic relation with each other may be registered in advance. As a result, different label names, if in synonymic relation with each other, can be determined as coincident with each other.

As described above, the status of each robot can be specified based on the label name assigned to each robot status.

According to an object management apparatus, an object management method, and a computer program product, the use of the status variable at a primitive level leads to the advantage that the status of each object can be specified without regardless of the type of the object. Specifically, the status of each object providing a service can be appropriately determined even when heterogenous devices, different makers or different industries coexist in the service provided by a device connected to a ubiquitous network or the service provided on the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An object management apparatus for managing an object which executes a process, comprising:
an execution conditions holding unit that holds the process and corresponding execution condition indicating a first status of the object as a prerequisite for executing the process;
an execution instruction acquisition unit that acquires an execution instruction indicating the process;
a status information acquisition unit that acquires status information indicating a second status of the object from the object; and
a status determining unit that determines whether the process indicated in the execution instruction can be executed by the object, based on the first status indicated in the execution condition corresponding to the process indicated in the execution instruction and the second status indicated the status information.

2. The object management apparatus according to claim 1,
wherein the status of the object is indicated by a status variable representing a unit of state,
the execution conditions holding unit holds the execution conditions including the status variable of the object,
the status information acquisition unit acquires the status information including the status variable, and
the status determining unit determines whether the process indicated in the execution instruction can be executed by the object, based on the status variable contained in the status information and the status variable contained in the execution conditions.

3. The object management apparatus according to claim 2, further comprising a coincidence degree calculation unit that calculates a degree of coincidence between the status variable contained in the status information and the status variable contained in the execution conditions,
wherein the status determining unit determines that the process indicated in the execution instruction can be executed by the object when the degree of coincidence calculated by the coincidence degree calculation unit is not less than a predetermined value.

4. The object management apparatus according to claim 2, further comprising a status variable specifying unit that specifies that the status variable is one of a dynamic status variable likely to change and a static status variable unlikely to change, based on the status variable contained in the status information acquired by the status information acquisition unit,
wherein the status determining unit determines whether the process indicated in the execution instruction can be executed by the object, based on the dynamic status variable specified by the status variable specifying unit and the status variable contained in the execution conditions.

5. The object management apparatus according to claim 4,
wherein the status determining unit, upon determination that the process indicated in the execution instruction can be executed by the object based on the dynamic status variable and the status variable contained in the execution conditions, further determines whether the process indicated in the execution instruction can be executed by the object, based on the static status variable and the status variable contained in the execution conditions.

6. The object management apparatus according to claim 2, further comprising a status variables relation information holding unit that holds status variables relation information indicating a relation between the status variables,
wherein the status determining unit determines whether the process indicated in the execution instruction can be executed by the object, based on (1) another status variable related, by the status variables relation information held in the status variables relation holding unit, to the status variable contained in the status information acquired by the status information acquisition unit, and (2) the status variable contained in the execution conditions.

7. The object management apparatus according to claim 6,
wherein the status variables relation information holding unit holds a status variables relation indicating a connotative relation between the status variables.

8. The object management apparatus according to claim 6, further comprising a concept conversion unit that converts the status variable contained in the status information acquired by the status information acquisition unit into a description logic concept based on a description logic, and converts the status variable contained in the execution conditions held by the execution conditions holding unit into the description logic concept,
wherein the status determining unit determines whether the process can be executed by the object, based on the description logic concept for the status information and the description logic concept for the execution conditions obtained by the concept conversion unit.

9. The object management apparatus according to claim 1,
wherein the execution conditions holding unit holds the execution conditions for each of a plurality of objects,
the status information acquisition unit acquires the status information from each object, and
the status determining unit determines whether the process indicated in the execution instruction can be executed by each object, based on the execution conditions and the status information for each object, and
the object management apparatus further comprises an object determining unit that determines an object to execute the process indicated in the execution instruction, based on the execution conditions and the execution state, among a plurality of the objects determined by the status determining unit as capable of executing the process indicated in the execution instruction.

10. The object management apparatus according to claim 9, further comprising a change frequency specifying unit that specifies a frequency at which a status of the object changes,
wherein the object determining unit determines an object to execute the process indicated in the execution instruction, based on the frequency specified by the change frequency specifying unit.

11. The object management apparatus according to claim 9,
wherein a status of the object is indicated by at least one status variable indicating a unit of status,
the execution conditions holding unit holds the execution conditions including the status variable of the object and a degree of importance corresponding to each status variable, and
the object determining unit determines an object to execute the process indicated in the execution instruction, based on the degree of importance of the status variable contained in the status information.

12. The object management apparatus according to claim 9,
wherein the object determining unit determines an object to execute the process indicated in the execution instruction, based on a relation between the status variable contained in the status information and the status variable contained in the execution conditions.

13. The object management apparatus according to claim 1, further comprising a status information holding unit that holds the status information acquired by the status information acquisition unit,
wherein the status information acquisition unit acquires the status information of the object different from the status information already held in the status information holding unit, and
the status determining unit determines whether the process indicated in the execution instruction can be executed by the object, based on the status information held in the status information holding unit and the execution conditions.

14. The object management apparatus according to claim 1, further comprising:
a status information holding unit that holds predetermined initial status information; and
a registration unit that causes, upon acquisition of the status information by the status information acquisition unit, the status information holding unit to hold the status information acquired by the status information acquisition unit in place of the initial status information,
wherein the status determining unit determines whether the process indicated in the execution instruction can be executed by the object, based on the status information held by the status information holding unit and the execution conditions.

15. The object management apparatus according to claim 1,
wherein the object is a robot whose status changes dynamically.

16. The object management apparatus according to claim 1,
wherein the object is a ubiquitous device whose status changes dynamically.

17. The object management apparatus according to claim 1,
wherein the object is a program whose status changes dynamically.

18. An object management method for managing an object which executes a process, comprising:
acquiring an execution instruction indicating the process to be executed by the object;
acquiring status information indicating a first status of the object from the object; and
determining whether the process indicated in the execution instruction can be executed by the object, based on the first status indicated in the execution condition corresponding to the process indicated in the execution instruction and the second status indicated the status information.

19. A computer program product for managing an object which executes a process, having a computer readable medium including programmed instructions, wherein the instructions, when executed by a computer, cause the computer to perform:.
acquiring an execution instruction indicating the process to be executed by the object;
acquiring status information indicating a first status of the object from the object; and
determining whether the process indicated in the execution instruction can be executed by the object, based on the first status indicated in the execution condition corresponding to the process indicated in the execution instruction and the second status indicated the status information.
